(19) United States
(12) Patent Application Publication
(10) Pub. No.: US 2026/0154942 A1
(43) Pub. Date: Jun. 4, 2026

(54) DATA PROCESSING METHOD AND APPARATUS, DEVICE, MEDIUM, AND PRODUCT

(71) Applicants: Beijing Zitiao Network Technology Co., Ltd., Beijing (CN); Beijing Youzhuju Network Technology Co., Ltd., Beijing (CN)

(72) Inventors: Li'ao Qu, Beijing (CN); Huichao Zhang, Beijing (CN); Yiheng Liu, Beijing (CN); Xu Wang, Beijing (CN); Yi Jiang, Beijing (CN); Yiming Gao, Beijing (CN); Hu Ye, Beijing (CN); Kang Du, Beijing (CN); Zehuan Yuan, Beijing (CN); Xinglong Wu, Beijing (CN)

(21) Appl. No.: 19/403,637

(22) Filed: Nov. 28, 2025

(30) Foreign Application Priority Data
Nov. 29, 2024 (CN) 202411751175.6

(51) Int. Cl. G06V 10/74; G06F 16/3329

(52) U.S. Cl. CPC G06V 10/761; G06F 16/33295

(57) ABSTRACT

The present application discloses a data processing method and apparatus, device, medium and product, where the method includes: acquiring a target image, a semantic-level feature of the target image, a pixel-level feature of the target image, a semantic-level codebook, and a pixel-level codebook, where a plurality of indices are shared between the semantic-level codebook and the pixel-level codebook, and different indices indicate different entries in the same codebook; summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index; and comparing the distance sums corresponding to the indices to obtain a minimum value, and determining an indexed result of the target image according to an index corresponding to the minimum value.

### CROSS-REFERENCE TO RELATED APPLICATION

This application claims priority to Chinese Patent Application No. 202411751175.6, entitled “DATA PROCESSING METHOD AND APPARATUS, DEVICE, MEDIUM, AND PRODUCT”, and filed on Nov. 29, 2024. The entire disclosure of the prior application is hereby incorporated by reference in its entirety.

### TECHNICAL FIELD

The present application relates to the field of data processing technologies, and in particular, to a data processing method and apparatus, device, medium, and product.

### BACKGROUND

In the field of visual language multimodality, a clear paradigm differentiation is presented between different tasks: a multimodal understanding task being implemented by an architecture formed by a visual encoder, a projection layer, and a pre-training language model, while a visual generation task is implemented by an autoregressive generation method based on discrete units (tokens).

### SUMMARY

The present application provides a data processing method and apparatus, a device, a medium, and a product.

In order to achieve the above objectives, the technical solution provided in the present application is as follows.

The present application provides a data processing method, including: acquiring a target image, a semantic-level feature of the target image, a pixel-level feature of the target image, a semantic-level codebook, and a pixel-level codebook, where a plurality of indices are shared between the semantic-level codebook and the pixel-level codebook, and different indices indicate different entries in the same codebook; summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index; comparing the distance sums corresponding to the plurality of indices to obtain a minimum value; and determining an indexed result of the target image according to an index corresponding to the minimum value.

In a possible implementation, the semantic-level feature and the pixel-level feature are both continuous features, and the entry is a discrete feature.

In a possible implementation, the target image includes a plurality of image patches, and the indexed result of the target image includes an indexed result of each of the image patches; and determining, for any of the image patches, the indexed result of the image patch includes: summing, for any of the indices, a distance between the entry indicated by the index in the semantic-level codebook and a semantic-level feature of the image patch and a distance between the entry indicated by the index in the pixel-level codebook and a pixel-level feature of the image patch to obtain a distance sum corresponding to the index for the image patch; comparing the distance sums corresponding to the plurality of indices for the image patch to obtain a minimum value for the image patch; and determining the indexed result of the image patch according to an index corresponding to the minimum value for the image patch.

In a possible implementation, the method is implemented by using a target model, where the target model includes a semantic-level encoder, a pixel-level encoder, the semantic-level codebook, and the pixel-level codebook; the semantic-level encoder is configured for acquiring the semantic-level feature; and the pixel-level encoder is configured for acquiring the pixel-level feature.

In a possible implementation, the target model further includes a semantic-level decoder and a pixel-level decoder, where the semantic-level decoder is configured for processing an entry indicated by the indexed result in the semantic-level codebook to obtain a semantic-level prediction result of the target image; and the pixel-level decoder is configured for processing an entry indicated by the indexed result in the pixel-level codebook to obtain a pixel-level prediction result of the target image; and the method further includes: determining a model loss according to the semantic-level prediction result, the pixel-level prediction result, the semantic-level feature, the pixel-level feature, the entry indicated by the indexed result in the semantic-level codebook, and the entry indicated by the indexed result in the pixel-level codebook; and updating the target model according to the model loss.

In a possible implementation, determining the model loss includes: determining a first loss according to a similarity between the semantic-level prediction result and a semantic feature extracted by a teacher model for the target image, where the semantic-level encoder is initialized according to the teacher model; summing a reconstruction loss determined based on the pixel-level prediction result and the target image, a perceptual loss determined based on the pixel-level prediction result and the target image, and an adversarial loss determined based on the pixel-level prediction result to obtain a second loss; determining a third loss according to the semantic-level feature, the pixel-level feature, the entry indicated by the indexed result in the semantic-level codebook, and the entry indicated by the indexed result in the pixel-level codebook; and determining the model loss according to the first loss, the second loss, and the third loss.

In a possible implementation, the method further includes: acquiring question text; and generating answer text according to the question text and the indexed result.

Ina possible implementation, the method further includes: obtaining an image reconstruction result corresponding to the target image according to the indexed result and the pixel-level codebook.

In a possible implementation, the target image includes a plurality of image patches, and the indexed result of the target image includes an indexed result of each of the image patches; and the method further includes: acquiring a text corresponding to the target image; generating an index prediction result of each of the image patches according to a generation model and the text; and updating the generation model according to a difference between the index prediction result of each of the image patches and the indexed result of each of the image patches.

In a possible implementation, after the updating the generation model, the method further includes: acquiring target text; predicting at least one index by using the generation model and the target text; and obtaining a generated image corresponding to the target text according to the at least one index and the pixel-level codebook.

The present application provides a data processing apparatus, including: a first acquisition unit configured to acquire a target image, a semantic-level feature of the target image, a pixel-level feature of the target image, a semantic-level codebook, and a pixel-level codebook, where a plurality of indices are shared between the semantic-level codebook and the pixel-level codebook, and different indices indicate different entries in the same codebook; a first processing unit configured to sum, for any of the indices, a distance between an entry indicated by the index in the semantic-level codebook and the semantic-level feature and a distance between an entry indicated by the index in the pixel-level codebook and the pixel-level feature to obtain a distance sum corresponding to the index; a second processing unit configured to compare the distance sums corresponding to the plurality of indices to obtain a minimum value; and a third processing unit configured to determine an indexed result of the target image according to an index corresponding to the minimum value.

The present application provides an electronic device, including: a processor and a memory, where the memory is configured to store instructions or a computer program; and the processor is configured to execute the instructions or computer program in the memory to cause the electronic device to perform the data processing method provided in the present application.

The present application provides a computer-readable medium having therein stored instructions or a computer program which, when run on a device, cause the device to perform the data processing method provided in the present application.

The present application provides a computer program product, including a computer program carried on a non-transient computer-readable medium, the computer program including program code for performing the data processing method provided in the present application.

### BRIEF DESCRIPTION OF THE DRAWINGS

In order to more clearly illustrate the technical solutions in the embodiments of the present application or the related arts, the drawings that need to be used in the description of the embodiments or the related arts will be briefly introduced below, and it is obvious that the drawings in the description below are only some embodiments described in the present application, and for one of ordinary skill in the art, other drawings can also be obtained according to the drawings without paying creative labor.

FIG. 1 is a flow diagram of a data processing method according to an embodiment of the present application;

FIG. 2 is a schematic diagram of a data processing process according to an embodiment of the present application;

FIG. 3 is a schematic structural diagram of a data processing apparatus according to an embodiment of the present application;

FIG. 4 is a schematic structural diagram of an electronic device according to an embodiment of the present application.

### DETAILED DESCRIPTION

Research has found that in the field of visual language multimodality, a clear paradigm differentiation is presented between different tasks: a multimodal understanding task being implemented by an architecture formed by a visual encoder, a projection layer and a pre-training language model, while a visual generation task is implemented by an autoregressive generation method based on discrete units (tokens).

Through research, it has also been found that to attempt to overcome the problems caused by the above differentiation, the following solution has been adopted: first, performing visual tokenization processing (also referred to as quantization processing) on a visual input to obtain a tokenized result, so that the tokenized result includes an index of at least one feature (e.g., discrete feature), and then implementing different tasks (e.g., the multimodal understanding task or image generation task) based on the tokenized result.

Through research, it has further been found that in the visual tokenization processing solution provided in the solution in the preceding paragraph, there are the following defects: \textcircled{1} although a pixel reconstruction-based tokenizer can preserve low-level visual details well, its semantic comprehension capability is limited, so that it performs excellently in image generation tasks, but performs poorly in multimodal understanding tasks. \textcircled{2} although the semantic-based tokenizer can capture high-level semantics well, it performs poorly in reconstructing fine visual details, so that it performs well in multimodal understanding tasks, but performs badly in the image generation task. It can be seen that these visual tokenization processing solution face a trade-off between semantic understanding and visual detail representation, making it difficult to develop a unified framework that simultaneously supports both multimodal understanding and image generation tasks.

It should be noted that the token is a symbol, so that it is used for representing a basic unit (such as a word in a text or an image patch in an image) for a certain type of data. For example, the token may be implemented by using an index similar to that in a dictionary (such as a vocabulary, a certain type of codebook), so that the token can represent an entry (e.g., a word or discrete feature) indicated by the token in the dictionary to participate in some data processing processes.

Compared with the related arts, the present application has at least the following advantages:
the visual tokenization processing solution provided in the present application including: first, acquiring a target image, a semantic-level feature of the image, a pixel-level feature of the image, a semantic-level codebook, and a pixel-level codebook, where a plurality of indices are shared between the semantic-level codebook and the pixel-level codebook, and different indices indicate different entries in the same codebook; then summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index, so that the distance sum can represent a loss presented on semantic-level information and pixel-level information when the image is represented by using the index; next, comparing the distance sums corresponding to the indices to obtain a minimum value, so that the minimum value can represent that an index corresponding to the minimum value can most accurately represent semantic-level information and pixel-level information carried by the image, so as to determine an indexed result of the target image subsequently according to the index corresponding to the minimum value, so that the indexed result can, by tokenization, jointly represent the semantic-level information and pixel-level information carried by the image, and thus the indexed result can give consideration to both semantic understanding and visual detail representation, and then defects caused by the fact that some solutions are difficult to give consideration to both semantic understanding and visual detail representation can be effectively overcome.

In addition, the indices are shared between the semantic-level codebook and the pixel-level codebook, so that the visual tokenization processing implemented based on the two codebooks can map different levels of features (such as a high level of semantic-level feature and a low level of pixel-level feature) to the same space (such as a discrete token space), which can implement effective fusion of the different levels of features, and thus can implement unification of the semantic comprehension capability and the visual detail reconstruction capability, and then can fill a gap between a multimodal understanding task and a visual generation task as much as possible, so that different tasks (such as the multimodal understanding task and the visual generation task) implemented based on the visual tokenization processing are all presented with relatively good effects.

Furthermore, the visual tokenization processing solution provided in the present application has good expandability, so that the solution can not only be implemented based on the two codebooks, but also can be extended by incorporating additional codebooks (such as a codebook for describing various contour information, a codebook for describing various depth information, and a codebook for describing various heat map information), and the performance is continuously improved with the increase of the number of the codebooks.

In order to make those skilled in the art better understand the solutions of the present application, the technical solutions in the embodiments of the present application will be clearly and completely described below with reference to the drawings in the embodiments of the present application, and it is obvious that the described embodiments are only some of the embodiments of the present application, and not all of the embodiments. All other embodiments, which are obtained by one of ordinary skill in the art without making creative labor based on the embodiments in the present application, are within the scope of protection of the present application.

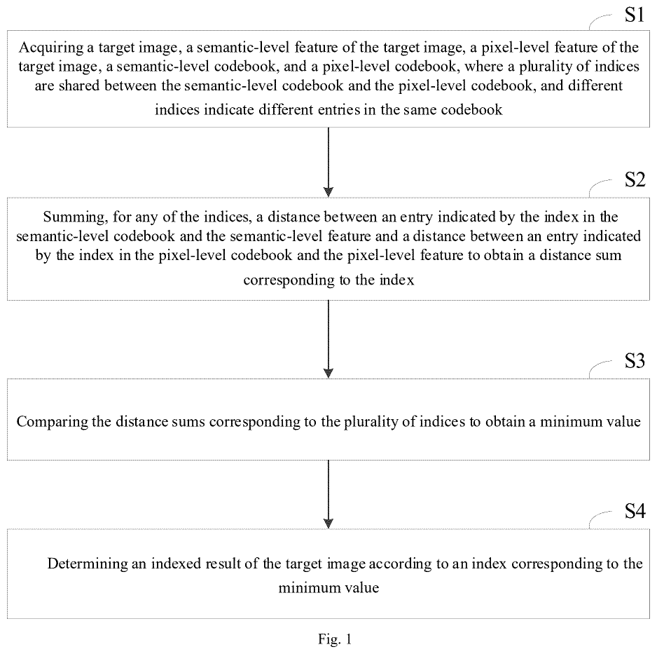

In order to better understand the technical solutions provided in the present application, a data processing method provided in the present application is first explained below in conjunction with some drawings. As shown in FIG. 1, the data processing method provided in an embodiment of the present application includes S1-S4 hereinafter.

S1: acquiring a target image, a semantic-level feature of the target image, a pixel-level feature of the target image, a semantic-level codebook, and a pixel-level codebook, where a plurality of indices are shared between the semantic-level codebook and the pixel-level codebook, and different indices indicate different entries in the same codebook.

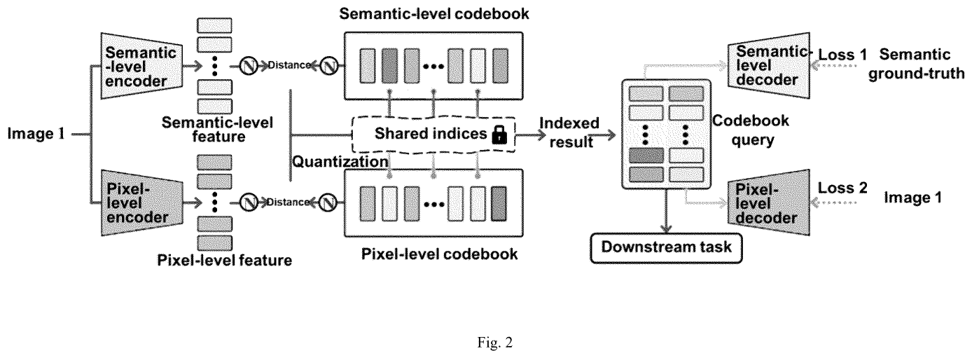

The target image refers to an image that needs visual tokenization processing, such as image 1 shown in FIG. 2, an image involved in a multimodal understanding task, an image ground-truth involved in a training process of a generation model used in a visual generation task, or an image that needs reconstruction processing in an image reconstruction task.

The semantic-level feature of the target image are used for representing high-level information carried by the image, i.e., semantic-level information, such as a bird. In addition, the semantic-level feature is a continuous feature. Furthermore, the present application does not limit the representation of the semantic feature, for example, it can be implemented by using formula (1) hereinafter. Moreover, the present application does not limit the acquisition of the semantic-level feature, for example, it can be implemented based on a contrastive language-image pre-training (CLIP) model by using any machine learning model capable of extracting a semantic-level feature from an image.

$${\hat{Z}}_{sem} = {ε}_{sem} ( x ) ∈ {ℝ}^{{d}_{sem}} \qquad ( 1 )$$

Where \hat{Z}ₛₑₘ represents a semantic-level feature of an image (e.g., the above target image); x represents the image; εₛₑₘ(⋅) represents semantic-level feature extraction processing; and [symbol] ^{d}^{ₛₑₘ} represents a feature space of the semantic-level feature, dₛₑₘ representing a dimension of the semantic-level feature.

The pixel-level feature of the target image is used for representing low-level information carried by the image, i.e., pixel-level information, e.g., color distribution. In addition, the pixel-level feature is a continuous feature. Furthermore, the present application does not limit the representation of the pixel-level feature, for example, it can be implemented by using formula (2) hereinafter. Moreover, the present application does not limit the acquisition of the pixel-level feature, for example, it can be implemented by using any machine learning model capable of extracting a pixel-level feature from an image.

$${\hat{Z}}_{pix} = {ε}_{pix} ( x ) ∈ {ℝ}^{{d}_{pix}} \qquad ( 2 )$$

Where \hat{Z}ₚᵢₓ represents a pixel-level feature of an image (e.g., the above target image); x represents the image; εₚᵢₓ(⋅) represents pixel-level feature extraction processing; and [symbol] ^{d}^{ₚᵢₓ} represents a feature space of the pixel-level feature, dₚᵢₓ representing a dimension of the pixel-level feature.

The semantic-level codebook is used for recording representation vectors (such as discrete features) of various semantic-level information, so that the semantic-level codebook is equivalent to a dictionary where various vectors are recorded, so as to subsequently enable a vector matched with the target image to be queried by using the codebook and a tokenization processing result for the image to be determined by using an index of the matched vector.

In addition, the semantic-level codebook may satisfy at least the following constraints: the codebook including a plurality of entries, where different entries are used for representing different semantic-level information, and different entries have different indices. The entry refers to a unit that exists in one codebook, can be queried, and is indicated (or identified) by using a unique index; and the index of the entry is used for uniquely identifying the entry.

It should be noted that the present application does not limit the implementation of the entry, for example, in some scenarios, for example, in a scenario where a continuous feature needs discretization processing, the entry can be a discrete feature, so as to subsequently enable a discrete feature corresponding to any continuous feature to be queried by retrieving the codebook.

Furthermore, the present application does not limit the representation of the semantic-level codebook, for example, it can be implemented by using formula (3) hereinafter.

$${Z}_{sem} = \{ {Z}_{sem , 1} , {Z}_{sem , 2} , … , {Z}_{sem , K} \} ∈ {ℝ}^{K \times {d}_{sem}} \qquad ( 3 )$$

Where Zₛₑₘ represents a semantic-level codebook; z_{sem,i} represents an i-th entry in the codebook, such as a semantic-level embedding vector with an index i as an identification; i represents an index of the z_{sem,i}, and i=1, 2, . . . , or K; K represents the number of entries in the codebook, and K is a positive integer; and [symbol] ^{K×d}^{ₛₑₘ} represents a codebook space of the semantic-level codebook.

The pixel-level codebook is used for recording representation vectors (such as discrete features) of various pixel-level information, so that the pixel-level codebook is equivalent to a dictionary where various vectors are recorded, so as to subsequently enable a vector matched with the target image to be queried by using the codebook and a tokenization processing result for the image to be determined by using an index of the matched vector.

In addition, the pixel-level codebook may satisfy at least the following constraints: the codebook including a plurality of entries, where different entries are used for representing different pixel-level information, and different entries have different indices.

Furthermore, the indices are shared between the semantic-level codebook and the pixel-level codebook, so that entries in the two codebooks that correspond to the same index can be jointly represented at a semantic level and a pixel level, thereby enabling highly diverse combinations of semantic information and pixel information to be described by means of the two codebooks, which can achieve better image reconstruction and multimodal understanding performance while improving utilization efficiency.

Moreover, the present application does not limit the representation of the pixel-level codebook, for example, it can be implemented by using formula (4) hereinafter.

$${Z}_{pix} = \{ {Z}_{pix , 1} , {Z}_{pix , 2} , … , {Z}_{pix , K} \} ∈ {ℝ}^{K \times {d}_{pix}} \qquad ( 4 )$$

where Zₚᵢₓ represents a pixel-level codebook; z_{pix,i} represents an i-th entry in the codebook, such as a pixel-level embedding vector with an index i as an identification; i represents an index of the z_{pix,i}, and i=1, 2, . . . , or K; K represents the number of entries in the codebook, and K is a positive integer; and [symbol] ^{K×d}^{ₚᵢₓ} represents a codebook space of the pixel-level codebook.

Based on the related content of the S1 hereinbefore, it can be seen that after the target image is acquired, the semantic-level feature and the pixel-level feature are respectively extracted for the image, so that the two features respectively represent different levels of image information, so as to subsequently enable the two features to be mapped to the same space (e.g., a discrete token space) by means of the semantic-level codebook and the pixel-level codebook between which the indices are shared, to implement effective fusion of the features of different levels.

S2: summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index.

An index i is used for indicating (or identifying) an i-th entry in the semantic-level codebook, and the i-th entry is used for representing a type of semantic-level information, such as a bird, where i is a positive integer, and i≤K.

Meanwhile, the index i is also used for indicating (or identifying) an i-th entry in the pixel-level codebook, and the i-th entry is used for representing a type of pixel-level information, such as color distribution, where i is a positive integer, and i≤K.

In addition, a distance sum corresponding to the index i is used for representing a possibility of representing the target image by using the index i as a token; and the distance sum may be obtained by using formulas (5)-(7) hereinafter.

$${D}_{sem , i} = {‖ {\hat{Z}}_{sem} - {Z}_{sem , i} ‖}_{2}^{2} \qquad ( 5 )$$

$${D}_{pix , i} = {‖ {\hat{Z}}_{pix} - {Z}_{pix , i} ‖}_{2}^{2} \qquad ( 6 )$$

$${SUM}_{dis , i} = {D}_{sem , i} + {w}_{dis} \times {D}_{pix , i} \qquad ( 7 )$$

where SUM_{dis,i} represents a distance sum corresponding to an index i; \hat{z}ₛₑₘ represents a semantic-level feature extracted from an image (e.g., the target image); z_{sem,i} represents an entry indicated (or identified) by the index i in a semantic-level codebook; D_{sem,i} represents a distance between the \hat{z}ₛₑₘ and

$${Z}_{sem , i} ; {‖ \cdot ‖}_{2}^{2}$$

represents a calculation function of an l₂-norm distance; \hat{z}ₚᵢₓ represents a pixel-level feature extracted from the image; z_{pix,i} represents an entry indicated (or identified) by the index i in a pixel-level codebook; D_{pix,i} represents a distance between the \hat{z}ₚᵢₓ and z_{pix,i}; and w_{dis} represents a balance weight to balance influences of the two distances.

It should be noted that the present application does not limit the implementation of the above w_{dis}, for example, w_{dis}=1.

Based on the related content of the above S2, it can be seen that after a semantic-level feature and pixel-level feature of a target image are acquired, it is possible to determine, according to a distance between the semantic-level feature and each entry in a semantic-level codebook and a distance between the pixel-level feature and each entry in a pixel-level codebook, a distance sum of each index shared between the two codebooks, so that the distance sum can represent differences between a discrete feature indicated by each index and high and low levels of continuous features of the image, and thus the distance sum can represent a possibility of representing the target image by using each index as a token.

S3: comparing the distance sums corresponding to the plurality of indices to obtain a minimum value.

S4: determining an indexed result of the target image according to an index corresponding to the minimum value.

The indexed result of the target image is used for jointly representing, by a token, the semantic-level information and pixel-level information carried by the image, so that the indexed result includes the index corresponding to the above minimum value.

In addition, the above indexed result may be determined by using (8) hereinafter.

$$token = {argmin}_{i} ( {SUM}_{dis , i} ) = {argmin}_{i} ( {D}_{sem , i} + {w}_{dis} \times {D}_{pix , i} ) \qquad ( 8 )$$

where token represents an index corresponding to a minimum value;

$${argmin}_{i} ( \cdot )$$

represents a function for finding the index with the minimum distance sum.

Based on the related content of the above S1 to S4, it can be seen that the visual tokenization processing solution provided in the present application includes: first, acquiring a target image, a semantic-level feature of the image, a pixel-level feature of the image, a semantic-level codebook, and a pixel-level codebook, where a plurality of indices are shared between the semantic-level codebook and the pixel-level codebook, and different indices indicate different entries in the same codebook; then summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index, so that the distance sum can represent a loss presented on semantic-level information and pixel-level information when the image is represented by using the index; next, comparing the distance sums corresponding to the indices to obtain a minimum value, so that the minimum value can represent that an index corresponding to the minimum value can most accurately represent semantic-level information and pixel-level information carried by the image, so as to determine an indexed result of the target image subsequently according to the index corresponding to the minimum value, so that the indexed result can, by tokenization, jointly represent the semantic-level information and pixel-level information carried by the image, and thus the indexed result can give consideration to both semantic understanding and visual detail representation, and then defects caused by the fact that some solutions are difficult to give consideration to both semantic understanding and visual detail representation can be effectively overcome.

In addition, the indices are shared between the semantic-level codebook and the pixel-level codebook, so that the visual tokenization processing implemented based on the two codebooks can map different levels of features (such as a high level of semantic-level feature and a low level of pixel-level feature) to the same space (such as a discrete token space), which can implement effective fusion of the different levels of features, and thus can implement unification of the semantic comprehension capability and the visual detail reconstruction capability, and then can fill a gap between a multimodal understanding task and a visual generation task as much as possible, so that different tasks (such as the multimodal understanding task and the visual generation task) implemented based on the visual tokenization processing are all presented with relatively good effects.

Furthermore, the visual tokenization processing solution provided in the present application has good expandability, so that the solution can not only be implemented based on the two codebooks, but also can be extended by incorporating additional codebooks (such as a codebook for describing various contour information, a codebook for describing various depth information, and a codebook for describing various heat map information), and the performance is continuously improved with the increase of the number of the codebooks.

Moreover, the present application does not limit an execution subject of the data processing method, for example, the method can be applied to a terminal device or server. For another example, the method can also be implemented by means of data interaction between the terminal device and the server. The terminal device can be a smart phone, computer, personal digital assistant (PDA), tablet personal computer, etc. The server can be a stand-alone server, cluster server, or cloud server.

Through research, it has been found that, since some images are larger, in order to better enhance the effect of the visual tokenization processing, the present application also provides a possible implementation of the data processing method, where it may include steps 11-14 hereinafter.

Step 11: acquiring a target image.

Step 12: performing division processing on the target image to obtain a plurality of image patches.

It should be noted that the present application does not limit the implementation of the above step 12, for example, it can be implemented by using any method capable of performing division processing on an image.

Step 13: determining an indexed result of each image patch according to a semantic-level feature of each image patch, a pixel-level feature of each image patch, a semantic-level codebook, and a pixel-level codebook.

An m-th image patch refers to an image patch which exists in the target image and is located at an m-th arrangement position, where m is a positive integer, and ms M, M being a positive integer, and M representing the number of the image patches in the plurality of image patches described above.

The semantic-level feature of the m-th image patch is used for representing semantic-level information carried by the m-th image patch. It should be noted that the semantic-level feature may be represented by using the formula (1) hereinbefore.

The pixel-level feature of the m-th image patch is used for representing pixel-level information carried by the m-th image patch. It should be noted that the pixel-level feature may be represented by the formula (2) hereinbefore.

An indexed result of the m-th image patch is used for jointly representing, by a token, the semantic-level information and pixel-level information carried by the m-th image patch; and the indexed result of the m-th image patch may be implemented by using the tokenization process shown in the formulas (1)-(8) hereinbefore or a quantization process shown in FIG. 2.

It can be seen that a determining process of the above indexed result of the m-th image patch can be: first, for any index (such as an index i), acquiring a distance (such as D_{sem,i}) between an entry indicated by the index in the semantic-level codebook and the semantic-level feature of the m-th image patch, acquiring a distance (such as D_{pix,i}) between an entry indicated by the index in the pixel-level codebook and the pixel-level feature of the m-th image patch, and summing the two distances to obtain a distance sum (such as SUM_{dis,i}) corresponding to the index for the m-th image patch; then, comparing the distance sums corresponding to all the indices for the m-th image patch to obtain a minimum value for the m-th image patch; and finally, according to an index corresponding to the minimum value, e.g., token shown in the formula (8), determining the indexed result of the m-th image patch, so that the indexed result includes the index corresponding to the minimum value.

Based on the related content of the step 13 hereinbefore, it can be seen that for the m-th image patch, the indexed result of the m-th image patch is determined according to the distance between the semantic-level feature of the m-th image patch and each entry in the semantic-level codebook and the distance between the pixel-level feature of the m-th image patch and each entry in the pixel-level codebook, so that the distance sum corresponding to the indexed result is minimized, and thus the indexed result can better jointly represent the semantic-level information and pixel-level information carried by the m-th image patch, where m≤M.

Step 14: determining an indexed result of the target image according to the indexed results of the plurality of image patches, so that the indexed result of the target image includes the indexed result of each image patch.

It should be noted that the present application does not limit the implementation of the step 14, for example, it can specifically be: first, according to an arrangement order of all the image patches, ranking the indexed results of the plurality of image patches to obtain an index sequence; and then, using the index sequence as the indexed result of the target image, so that the indexed result can, by a token sequence, jointly represent the semantic-level information and pixel-level information carried by the image.

Based on the related content of the steps 11 to 14 hereinbefore, it can be seen that for an image in a large size, first, the image is divided into a plurality of image patches, such as 3×3 image patches; then, each image patch is mapped to a discrete token space by means of a semantic-level codebook and a pixel-level codebook to obtain an indexed result of each image patch, to implement visual tokenization processing for each image patch; and then, based on the indexed results of all the image patches, an index sequence is constructed so that the sequence can represent the result of the visual tokenization processing for the image, and thus the sequence can jointly represent semantic-level information and pixel-level information carried by the image.

In addition, in order to better improve the effect, the data processing method provided in the present application can be implemented by using a target model. The model at least includes a semantic-level encoder, a pixel-level encoder, the semantic-level codebook, and the pixel-level codebook, where the semantic-level encoder is configured for acquiring the above semantic-level feature, the pixel-level encoder is configured for acquiring the above pixel-level feature, and the two codebooks are configured for performing visual tokenization processing (such as quantization processing) for output data of the two encoders, so that the model can separately extract different levels of features by means of the dual encoders, and map all the levels of features to the same space by means of the two codebooks between which indices are shared, to better implement effective fusion of the multiple levels of features.

Furthermore, the above target model may further include a semantic-level decoder and a pixel-level decoder, where the semantic-level decoder is configured for performing processing (decoding processing) on an entry indicated by the above indexed result in the semantic-level codebook to obtain a semantic-level prediction result of the target image, so that the semantic-level prediction result can represent semantic-level information extracted by the model from the image; and the pixel-level decoder is configured for performing processing (e.g., decoding processing) on an entry indicated by the indexed result in the pixel-level codebook to obtain a pixel-level prediction result of the target image, so that the pixel-level prediction result can represent an image reconstructed by the model for the target image, and thus the pixel-level prediction result can represent pixel-level information extracted by the model from the target image, such as a state (e.g., color) in which each pixel is presented.

Moreover, for the target model described in the above paragraph, the present application also provides a training method for the model, for example, it can include steps 21-25 hereinafter.

Step 21: acquiring a target image, so that the target image can represent an image that needs to be processed during the current round of training, such as image 1 shown in FIG. 2.

Step 22: inputting the target image into the target model, so that the model performs processing for the image to obtain a semantic-level feature of the target image, a pixel-level feature of the target image, an indexed result of the target image, a semantic-level prediction result of the target image, and a pixel-level prediction result of the target image.

Step 23: determining a model loss according to the semantic-level prediction result of the target image, the pixel-level prediction result of the target image, the semantic-level feature of the target image, the pixel-level feature of the target image, an entry indicated by the indexed result of the target image in the semantic-level codebook, and an entry indicated by the indexed result in the pixel-level codebook, so that the loss can represent performance of the target model.

It should be noted that the present application does not limit the implementation of the step 23, for example, to better improve the training effect, the step 23 can include steps 231-234 hereinafter.

Step 231: determining a first loss (such as loss 1 shown in FIG. 2) according to a similarity between the semantic-level prediction result of the target image and a semantic feature extracted by a teacher model for the target image, so that the first loss can represent a semantic-level loss. The semantic-level encoder is initialized according to the teacher model.

The teacher model is used for guiding performance presented by the target model on the semantic level; moreover, the present application does not limit the implementation of the teacher model, for example, it can be implemented by using any CLIP model (e.g., CLIP ViT-B/14 model).

In addition, to better improve performance, the semantic-level encoder in the target model may be initialized according to the teacher model, so that when the teacher model is implemented by using the CLIP ViT-B/14 model, this initialization strategy helps to learn high-level text alignment embedding better in the semantic-level codebook to enhance performance presented by the target model on the multimodal understanding task.

Furthermore, the present application does not limit the implementation of the step 231, for example, it can specifically be: calculating an l₂-norm distance between the semantic-level prediction result of the target image and the semantic feature extracted by the teacher model for the target image as the first loss.

For another example, when the target image includes M image patches and the semantic-level prediction result of the target image includes a semantic-level prediction result of each image patch, the above step 231 may include: first, calculating an l₂-norm distance between a semantic-level prediction result of an m-th image patch and a semantic feature extracted by the teacher model for the m-th image patch as a semantic prediction loss of the m-th image patch, so that the semantic prediction loss of the m-th image patch can represent a loss presented by the m-th image patch on a semantic level, where m is a positive integer, and m M; and then, summing the semantic prediction losses of all the image patches to obtain the first loss, so that the first loss can represent a loss presented by the target image on the semantic level.

It should be noted that, for the m-th image patch, determining the semantic-level prediction result of the m-th image patch includes: after an indexed result of the m-th image patch is acquired, first searching an entry indicated (or identified) by the indexed result from the semantic-level codebook as a discrete feature closest to the m-th image patch; and then, processing, by the semantic-level decoder, the discrete feature to obtain a semantic-level decoded feature for the m-th image patch, so that the decoded feature can represent semantic information (such as a puppy) carried by the m-th image patch, and using the decoded feature as the semantic-level prediction result of the m-th image patch.

Based on the related content of the step 231 hereinbefore, after output data of the semantic-level decoder in the target model is acquired, a first loss is determined according to a difference between the output data and the semantic feature extracted by the teacher model for the target image, so that the loss can represent a loss in semantic prediction.

Step 232: summing a reconstruction loss determined based on the pixel-level prediction result of the target image and the target image, a perceptual loss determined based on the pixel-level prediction result and the target image, and an adversarial loss determined based on the pixel-level prediction result, to obtain a second loss (such as loss 2 shown in FIG. 2), so that the second loss can represent a pixel-level loss.

It should be noted that the present application does not limit the implementation of the step 232, for example, it can be implemented by using formula (9) hereinafter.

$${ℒ}_{pix} = {ℓ}_{2} ( x , \hat{x} ) + {ℒ}_{P} ( x , \hat{x} ) + {λ}_{G} {ℒ}_{G} ( \hat{x} ) \qquad ( 9 )$$

Where [symbol] ₚᵢₓ represents a second loss; [symbol] ₂(⋅) represents a calculation function of a reconstruction loss; x represents a target image; \hat{x} represents a pixel-level prediction result of the target image, such as a reconstructed image; [symbol] _{P}(⋅) represents a calculation function of a perception loss, such as an implementation function of a learned perceptual image patch similarity (LPIPS) algorithm; [symbol] _{G}(⋅) represents a calculation function of an adversarial loss; and λ_{G} represents a weight of the adversarial loss.

It should be noted that the present application does not limit the implementations of the reconstruction loss, perceptual loss, and adversarial loss, for example, each loss can be implemented by using any corresponding loss calculation method that is present or appears in the future.

Step 233: determining a third loss according to the semantic-level feature of the target image, the pixel-level feature of the target image, the entry indicated by the indexed result of the target image in the semantic-level codebook, and the entry indicated by the indexed result in the pixel-level codebook, so that the third loss can represent a loss in representation performance of each entry in the codebook.

It should be noted that the present application does not limit the implementation of the step 233, for example, it can be implemented by means of formula (10) hereinafter.

$${ℒ}_{VQ} = {‖ sg [ \hat{z} ] + z ‖}_{2}^{2} + β {‖ \hat{z} - sg [ z ] ‖}_{2}^{2} \qquad ( 10 )$$

where [symbol] _{VQ} represents a codebook learning target (also referred to as a quantization loss); \hat{z} represents a continuous feature, such as a semantic-level feature of a target image (or a pixel-level feature of the target image); z represents a discrete feature (also referred to as a quantization processing result for the \hat{z}) closest to the continuous feature, such as an entry indicated by an indexed result of the target image in a semantic-level codebook (or an entry indicated by the indexed result in a pixel-level codebook); and sg[⋅] represents a stop-gradient operation).

It can be seen that, when the target image includes M image patches, determining the above third loss may include: first, calculating, by using the formula (10), a quantization loss between a semantic-level feature of an m-th image patch and a quantization processing result (such as an entry indicated by an indexed result of the m-th image patch in a semantic-level codebook) of the semantic-level feature as a corresponding quantization loss of the m-th image patch at a semantic level, and calculating, by using the formula (10), a quantization loss between a pixel-level feature of the m-th image patch and a quantization processing result (such as an entry indicated by the indexed result of the m-th image patch in a pixel-level codebook) of the pixel-level feature as a corresponding quantization loss of the m-th image patch at a pixel level, where m is a positive integer, and m≤M; and then, summing all the quantization losses of all the image patches to obtain the third loss.

Step 234: determining a model loss according to the first loss, the second loss, and the third loss, so that the loss can represent the performance of the target model.

It should be noted that the present application does not limit the implementation of the step 234, for example, it can be implemented by using formula (11) hereinafter.

$${ℒ}_{total} = {ℒ}_{sem} + {ℒ}_{pix} + {ℒ}_{vq} \qquad ( 11 )$$

where [symbol] ₜₒₜₐₗ represents a model loss; [symbol] ₛₑₘ represents a first loss; [symbol] ₚᵢₓ represents a second loss; and [symbol] _{vq} represents a third loss.

Based on the related content of the above steps 231 to 234, it can be seen that, for a target model, a model loss of the model can be calculated by using various data generated when the target model processes a target image, so that the loss can represent the performance of the model as accurately as possible.

Step 24: updating the target model according to the model loss, and returning to continue executing the above step 21 and its subsequent steps until a preset stop condition (for example, the loss being lower than a preset loss threshold, a change rate of the loss being lower than a preset change rate threshold, or the number of updates of the target model reaching a preset number threshold, and the like) is reached, at which point the iterative training process for the target model is terminated.

It should be noted that the present application does not limit the implementation of the step of “updating the target model”, for example, when the model includes a semantic-level encoder, a pixel-level encoder, a semantic-level codebook, a pixel-level codebook, a semantic-level decoder, and a pixel-level decoder, an updating process of the model is: updating parameter(s) in the semantic-level encoder, updating parameter(s) in the pixel-level encoder, updating entries in the semantic-level codebook, updating entries in the pixel-level codebook, updating parameter(s) in the semantic-level decoder, and updating parameter(s) in the pixel-level decoder, so that the updated model has better performance.

Based on the related content of the above steps 21 to 24, it can be seen that in some scenarios, a target model can be trained by using a training process shown in FIG. 2, so that the trained target model has better performance, such as visual tokenization processing performance, quantization performance, and image reconstruction performance, so as to subsequently enable various tasks, such as a multimodal understanding task, image reconstruction task, or text-to-image task to be implemented by means of the model. The model adopts an architecture of dual coders and a design of dual codebooks between which indices are shared, so that the model can keep a strong semantic comprehension capability and can present high-quality image reconstruction, and thus the model can effectively serve a multimodal understanding task and visual generation task simultaneously.

It should be noted that, for FIG. 2, a symbol “N” therein is used for representing normalization processing.

In addition, to better improve the tokenization representation effect, the present application also provides a multi-scale visual tokenization processing solution to enhance richness of codebook representation. For ease of understanding, processing for the m-th image patch is exemplified below.

As an example, visual tokenization processing for the above m-th image patch includes steps 31-34 hereinafter.

Step 31: initializing a to-be-transformed semantic feature by using the semantic-level feature of the m-th image patch, initializing a to-be-transformed pixel feature by using the pixel-level feature of the m-th image patch, and initializing the indexed result of the m-th image patch by using preset data (such as a null value or null set).

Step 32: for any index, summing a distance between the entry indicated by the index in the semantic-level codebook and the to-be-transformed semantic feature and a distance between the entry indicated by the index in the pixel-level codebook and the to-be-transformed pixel feature to obtain a distance sum corresponding to the index for the current round.

Step 33: comparing the distance sums corresponding to all the indices for the current round to obtain a minimum value for the current round.

Step 34: updating the indexed result of the m-th image patch by using an index corresponding to the minimum value for the current round, so that the updated indexed result includes the index, updating the to-be-transformed semantic feature by using a difference between the to-be-transformed semantic feature and the entry indicated by the index in the semantic-level codebook, so that the updated to-be-transformed semantic feature is used for representing the difference, updating the to-be-transformed pixel feature by using a difference between the to-be-transformed pixel feature and the entry indicated by the index in the pixel-level codebook, so that the updated to-be-transformed pixel feature is used for representing the difference, and returning to continue executing the above step 32 and its subsequent steps until a preset end condition (e.g., the number of updates reaching a preset number threshold or each difference being less than a preset difference threshold, etc.) is reached, at which point the iterative processing process is stopped, and storing the indexed result of the m-th image patch, so that subsequently, not only it is possible to determine the result of the visual tokenization processing of the target image based on the indexed result, but also it is possible to obtain a discrete feature as close as possible to the semantic-level feature of the m-th image patch by adding the entries indicated by the indices within the indexed result in the semantic-level codebook, and obtain a discrete feature as close as possible to the pixel-level feature of the m-th image patch by adding the entries indicated by the indices within the indexed result in the pixel-level codebook.

Based on the related content of the above steps 31 to 34, in the present application, a most matched index of any image patch (or target image) under different scales may be determined by an iterative loop, so that the indices as a whole can better represent various information carried by the image patch (or target image), thereby facilitating improvement in accuracy.

In addition, for the indexed result of the above target image, the indexed result can be used for implementing various tasks, such as a multimodal understanding task, image reconstruction task, or visual generation task. For ease of understanding, the implementation of each task is described separately below.

Example 1, the implementation of the above multimodal understanding task may include at least steps 41 to 42 hereinafter.

Step 41: acquiring question text, such as a text of “what is described in image 1”, so that the text can represent what question a user has raised for a target image.

Step 42: generating answer text according to the question text and an indexed result of the target image, so that the answer text can represent a reply given for the question based on the image.

It should be noted that the present application does not limit the determination of the answer text, for example, it can specifically be: first, performing word segmentation on the question text to obtain at least one word segment; then, determining indices matched with the word segments from a word codebook; then, based on the indices matched with the word segments, generating an indexed result (such as a token sequence) of the question text, so that the indexed result includes the indices matched with the word segments; next, inputting a result of splicing between the indexed result of the question text and the indexed result of the above target image into a pre-trained machine learning model to obtain answer text output by the model. The model is a pre-trained model capable of answer generation based on tokenized results of different modals.

For another example, in some scenarios, the determination of the above answer text can include: first, processing, by byte pair encoding (BPE) in large language and vision Assistant (LLaVA), question text to obtain a text feature (such as a discrete feature) of the question text; then, processing, by a projection layer in the LLaVA, an entry indicated by an indexed result of the above target image in a semantic-level codebook (and an entry indicated by the indexed result in a pixel-level codebook) to obtain a projection feature corresponding to the target image, so that the projection feature and the text feature belong to the same feature space; and then, processing, by a large language model in the LLaVA, the projection feature and the text feature to obtain answer text.

Based on the related content of the steps 41 to 42 hereinbefore, it can be seen that after an indexed result of a target image is acquired, a multimodal understanding task can be implemented based on the indexed result, so that the multimodal understanding task implemented based on the indexed result demonstrates better performance.

Example 2, the implementation of the above image reconstruction task may at least include step 51 hereinafter.

Step 51: obtaining an image reconstruction result corresponding to a target image according to an indexed result of the target image and a pixel-level codebook.

It should be noted that the present application does not limit the implementation of the above step 51, for example, it can specifically be: processing an entry indicated by the above indexed result in the pixel-level codebook by using a pixel-level decoder in a trained target model to obtain an image reconstruction result corresponding to the target image.

Based on the related content of the step 51 hereinbefore, it can be seen that in some scenarios, the reconstruction for one image can be implemented by means of part of processes in the pre-trained target model, which is beneficial to improving image reconstruction performance.

Example 3, when a target image includes a plurality of image patches and an indexed result of the target image includes indexed results of the image patches, training of a generation model for implementing a visual generation task may include at least steps 61-63 hereinafter.

Step 61: acquiring a text corresponding to a target image, so that the text is used for describing the image.

It should be noted that the present application does not limit the acquisition of the target image and the text corresponding to the target image, for example, it can be implemented by randomly extracting any image from a database.

Step 62: generating an index prediction result of each image patch in the target image according to a generation model and the text corresponding to the above target image.

The generation model is configured for implementing autoregressive generation; and the present application does not limit the implementation of the generation model, for example, it can be implemented by using a decoding module in a Transformer.

An index prediction result of an m-th image patch refers to an index predicted by the generation model for the m-th image patch, so that the index prediction result can represent what index is determined by the generation model from the codebook and used for representing information carried by the m-th image patch.

Furthermore, the present application does not limit the implementation of the above step 62, for example, when a target image includes M image patches, the step 62 may include: first, transforming a text corresponding to the target image into an index sequence (such as a token sequence); then, generating, by a generation model, an index prediction result of a 1st image patch according to the index sequence; then, generating, by the generation model, an index prediction result of a 2nd image patch according to the index sequence and the index prediction result of the 1st image patch (or an entry indicated by the index prediction result of the 1st image patch in a pixel-level codebook and an entry indicated by the index prediction result of the 1st image patch in a semantic-level codebook); then, generating, by the generation model, an index prediction result of a 3rd image patch according to the index sequence and the index prediction result of the 2nd image patch (or an entry indicated by the index prediction result of the 2nd image patch in the pixel-level codebook and an entry indicated by the index prediction result of the 2nd image patch in the semantic-level codebook); . . . (and so on); and then, generating, by the generation model, an index prediction result of an M-th image patch according to the index sequence and the index prediction result of the (M−1)-th image patch (or an entry of the index prediction result of the (M−1)-th image patch indicated in the pixel-level codebook and an entry of the index prediction result of the (M−1)-th image patch indicated in the semantic-level codebook).

Step 63: updating the generation model according to a difference between the index prediction result of each image patch and the indexed result of each image patch, and returning to continue executing the above step 61 and its subsequent steps until a preset stop condition (such as a model loss of the generation model being lower than a preset loss threshold, a change rate of the loss being lower than a preset change rate threshold, or the number of updates of the generation model reaching a preset number threshold) is reached, at which point the iterative training process for the generation model is terminated.

It should be noted that the model loss of the generation model is used for characterizing the performance of the model; moreover, the loss is determined according to the difference between the index prediction result of each image patch and the indexed result of each image patch, where the calculation of the loss is not limited in the present application.

Based on the related content of the steps 61 to 63 hereinbefore, it can be seen that for some scenarios, such as a visual generation scenario, after an indexed result of a target image is acquired, the indexed result can be used as a ground-truth to guide a generation model to better learn how to perform visual generation, so that the final trained generation model can present better performance on a visual generation task.

It can be seen that after the trained generation model is acquired, an image generation process (e.g., a text-to-image process) shown in steps 71-73 hereinafter may be implemented by using the model.

Step 71: acquiring target text, so that the text is used for describing what an image to be finally generated is, and thus the text can represent image generation needs of a user.

Step 72: predicting at least one index by using the trained generation model and the target text, so that the indices can represent what information is carried by the image to be generated based on the text.

It should be noted that the implementation of the step 72 is similar to that of the step 62 hereinbefore, which will not be repeated here for brevity.

Step 73: obtaining a generated image corresponding to the target text according to the at least one index and the pixel-level codebook.

It should be noted that the present application does not limit the implementation of the above step 73, for example, it can specifically be: processing an entry indicated by the at least one index in the pixel-level codebook by using a pixel-level decoder in the trained target model to obtain the generated image corresponding to the target text.

Based on the related content of the above steps 71 to 73, it can be seen that after a generation model is trained based on some texts and indexed results of their corresponding image ground-truths, the model can be configured for performing image generation according to any text, which is beneficial to better improving the text-to-image performance.

Based on the related content of the data processing method, the technical solution provided in the present application has the advantages shown \textcircled{1}-\textcircled{5} hereinafter.
\textcircled{1} The present application provides a novel image tokenization solution, where an architecture of dual coders and a design of dual codebooks between which mapping is shared are used, so that the solution can first extract different levels of features by a semantic coder and a pixel coder respectively, and then map the features to a unified discrete token space by joint optimization, implementing effective fusion of high-level and low-level features, so that the solution successfully implements the unification of semantic understanding and visual reconstruction capabilities, and compared with other related solutions, gains significant improvement in a multimodal understanding task, while keeping excellent image reconstruction quality.
\textcircled{2} The present application also employs a multi-scale structure (such as the multi-scale structure shown in the steps 31 to 34 hereinbefore) to enhance the richness of the codebook representation.
\textcircled{3} The present application implements learning of joint distribution of the high-level semantic and low-level features by sharing indices, so that the present application has better expandability, which is specifically: with the increase of the codebook size, the present application presenting continuous performance improvement in both generation and understanding tasks. Even if the codebook size is expanded to 131,072, high utilization of more than 95% can be still maintained, while the optimal image reconstruction quality and multimodal understanding performance are implemented.
\textcircled{4} The present application implements learning of joint distribution of the high-level semantic and low-level features by sharing indices, so that the present application has a better multi-task implementation capability, which is specifically: by learning the joint distribution of the semantic-level feature and the pixel-level feature, the present application filling a gap between generation and understanding tasks, so that the indexed result in the present application can perform well in both domains.
\textcircled{5} With the mechanism of sharing indices, the present application also allows seamless integration of more codebooks (such as a codebook for describing various edge information, codebook including various heat maps, and codebook including various depth maps) to embed other types of feature representations, implementing the expansion of more downstream tasks without modifying the architecture.

In addition, during research, a solution of performing multitask unification by means of dual encoders has been attempted, which is roughly: for an image, first, transforming a semantic feature of the image into a semantic-level token sequence by using an encoder, and transforming a pixel-level feature of the image into a pixel-level token sequence by using another encoder; then, splicing the two sequences to obtain a spliced sequence, so that the spliced sequence simultaneously carries semantic-level information and pixel-level information, so as to when it is determined that a downstream task is a multimodal understanding task, execute a subsequent process of the multimodal understanding task by using the semantic-level token sequence intercepted from the spliced sequence; while when it is determined that a downstream task is a visual generation task, execute a subsequent process of the visual generation task by using the pixel-level token sequence intercepted from the splicing sequence.

Furthermore, through further research on the solution shown in the above paragraph, it has been found that in the solution, there are the following defects: due to the need to set the dedicated tokenizer for each level of features, the complexity of the architecture and the computation overhead being increased; and due to the need to add one corresponding tokenizer each time one new level of features is added, the complexity of the architecture and the computation overhead being further increased.

Moreover, the present application implements learning of the joint distribution of the high-level semantic and low-level features by sharing indices, so that the present application implements token transformation by mapping all the levels of features to the same discrete token space, and thus the present application can acquire a token sequence which can jointly represent all the levels of features by only one transformation, and then the present application can effectively overcome the defects described in the preceding paragraph, which can greatly reduce the complexity and the calculation overhead on the premise of unification of multiple tasks.

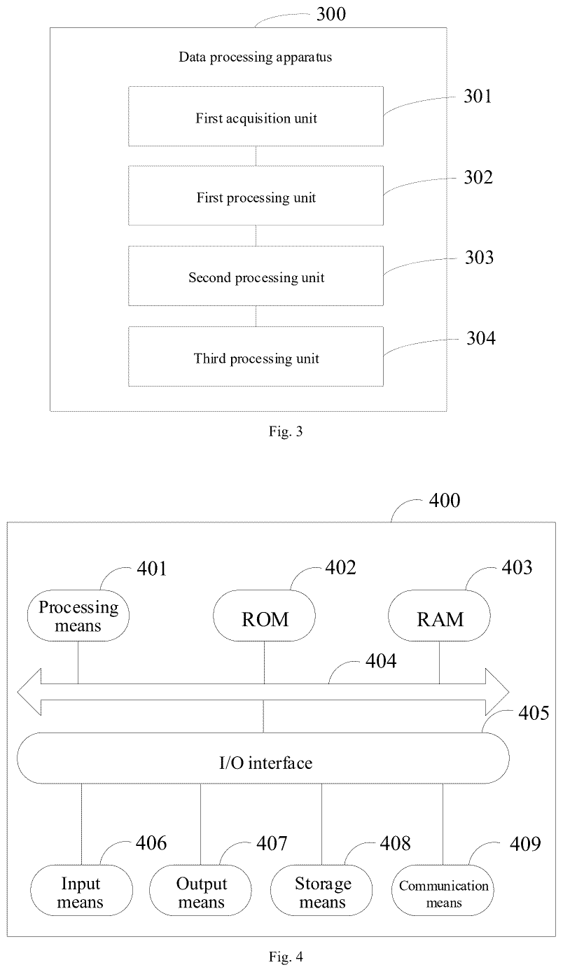

Based on the data processing method provided in the embodiment of the present application, an embodiment of the present application further provides a data processing apparatus, which is explained and described below with reference to FIG. 3. FIG. 3 is a schematic structural diagram of a data processing apparatus according to an embodiment of the present application. It should be noted that for the technical details of the data processing apparatus provided in the embodiment of the present application, please refer to the related content of the data processing method hereinbefore.

As shown in FIG. 3, the data processing apparatus 300 provided in the embodiment of the present application includes:
a first acquisition unit 301 configured to acquire a target image, a semantic-level feature of the target image, a pixel-level feature of the target image, a semantic-level codebook, and a pixel-level codebook, where a plurality of indices are shared between the semantic-level codebook and the pixel-level codebook, and different indices indicate different entries in the same codebook;
a first processing unit 302 configured to sum, for any of the indices, a distance between an entry indicated by the index in the semantic-level codebook and the semantic-level feature and a distance between an entry indicated by the index in the pixel-level codebook and the pixel-level feature to obtain a distance sum corresponding to the index;
a second processing unit 303 configured to compare the distance sums corresponding to the plurality of indices to obtain a minimum value; and
a third processing unit 304 configured to determine an indexed result of the target image according to an index corresponding to the minimum value.

In a possible implementation, the semantic-level feature and the pixel-level feature are both continuous features, and the entry is a discrete feature.

In a possible implementation, the image includes a plurality of image patches, and the indexed result of the target image includes an indexed result of each of the image patches; and determining, for any of the image patches, the indexed result of the image patch includes: summing, for any of the indices, a distance between the entry indicated by the index in the semantic-level codebook and a semantic-level feature of the image patch and a distance between the entry indicated by the index in the pixel-level codebook and a pixel-level feature of the image patch to obtain a distance sum corresponding to the index for the image patch; comparing the distance sums corresponding to the plurality of indices for the image patch to obtain a minimum value for the image patch; and determining the indexed result of the image patch according to an index corresponding to the minimum value for the image patch.

In a possible implementation, in the data processing apparatus 300, a target model is deployed, where the target model includes a semantic-level encoder, a pixel-level encoder, the semantic-level codebook, and the pixel-level codebook; the semantic-level encoder is configured for acquiring the semantic-level feature; and the pixel-level encoder is configured for acquiring the pixel-level feature.

In a possible implementation, the target model further includes a semantic-level decoder, and a pixel-level decoder, where the semantic-level decoder is configured for processing an entry indicated by the indexed result in the semantic-level codebook to obtain a semantic-level prediction result of the target image; and the pixel-level decoder is configured for processing an entry indicated by the indexed result in the pixel-level codebook to obtain a pixel-level prediction result of the target image; and
the data processing apparatus 300 further includes:
a first updating unit configured to determine a model loss according to the semantic-level prediction result, the pixel-level prediction result, the semantic-level feature, the pixel-level feature, the entry indicated by the indexed result in the semantic-level codebook, and the entry indicated by the indexed result in the pixel-level codebook; and update the target model according to the model loss.

In a possible implementation, determining the model loss includes: determining a first loss according to a similarity between the semantic-level prediction result and a semantic feature extracted by a teacher model for the target image, where the semantic-level encoder is initialized according to the teacher model; summing a reconstruction loss determined based on the pixel-level prediction result and the target image, a perceptual loss determined based on the pixel-level prediction result and the target image, and an adversarial loss determined based on the pixel-level prediction result to obtain a second loss; determining a third loss according to the semantic-level feature, the pixel-level feature, the entry indicated by the indexed result in the semantic-level codebook, and the entry indicated by the indexed result in the pixel-level codebook; and determining the model loss according to the first loss, the second loss, and the third loss.

In a possible implementation, the data processing apparatus 300 further includes:
a second acquisition unit configured to acquire question text; and
an answer generation unit configured to generate answer text according to the question text and the indexed result.

In a possible implementation, the data processing apparatus 300 further includes:
an image reconstruction unit configured to obtain an image reconstruction result corresponding to the target image according to the indexed result and the pixel-level codebook.

In a possible implementation, the image includes a plurality of image patches, and the indexed result of the target image includes an indexed result of each of the image patches; and
the data processing apparatus 300 further includes:
a third acquisition unit configured to acquire a text corresponding to the target image;
a first prediction unit configured to generate an index prediction result of each of the image patches according to a generation model and the text; and
a second updating unit configured to update the generation model according to a difference between the index prediction result of each of the image patches and the indexed result of each of the image patches.

In a possible implementation, the data processing apparatus 300 further includes:
a fourth acquisition unit configured to acquire target text;
a second prediction unit configured to predict at least one index by using the generation model and the target text; and
an image generation unit configured to obtain a generated image corresponding to the target text according to the at least one index and the pixel-level codebook.

Based on the related content of the above data processing apparatus 300, it can be seen that the working principle of the apparatus 300 includes: first, acquiring a target image, a semantic-level feature of the image, a pixel-level feature of the image, a semantic-level codebook, and a pixel-level codebook, where a plurality of indices are shared between the semantic-level codebook and the pixel-level codebook, and different indices indicate different entries in the same codebook; then, summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index, so that the distance sum can represent a loss presented on semantic-level information and pixel-level information when the image is represented by using the index; next, comparing the distance sums corresponding to the indices to obtain a minimum value, so that the minimum value can represent that an index corresponding to the minimum value can most accurately represent semantic-level information and pixel-level information carried by the image, so as to determine an indexed result of the target image subsequently according to the index corresponding to the minimum value, so that the indexed result can, by tokenization, jointly represent the semantic-level information and pixel-level information carried by the image, and thus the indexed result can give consideration to both semantic understanding and visual detail representation, and then defects caused by the fact that some solutions are difficult to give consideration to both semantic understanding and visual detail representation can be effectively overcome.

In addition, an embodiment of the present application further provides an electronic device, including a processor and a memory: the memory being configured to store instructions or a computer program; and the processor being configured to execute the instructions or computer program in the memory, so that the electronic device executes any implementation of the data processing method provided in the embodiment of the present application.

Referring to FIG. 4, a schematic structural diagram of an electronic device 400 suitable for implementing an embodiment of the present disclosure is shown. The terminal device in the embodiment of the present disclosure may include, but is not limited to, a mobile terminal such as a mobile phone, laptop, digital broadcast receiver, PDA (Personal Digital Assistant), PAD (tablet personal computer), PMP (Portable Multimedia Player), and vehicle-mounted terminal (e.g., vehicle-mounted navigation terminal), and a fixed terminal such as a digital TV and desk computer. The electronic device shown in FIG. 4 is only an example, and should not bring any limitation to the functions and the scope of use of the embodiment of the present disclosure.

As shown in FIG. 4, the electronic device 400 may include a processing means (e.g., central processing unit, graphics processing unit, etc.) 401 that may perform various appropriate actions and processes according to a program stored in a read-only memory (ROM) 402 or a program loaded from a storage means 408 into a random access memory (RAM) 403. In the RAM 403, various programs and data required for the operation of the electronic device 400 are also stored. The processing means 401, ROM 402, and RAM 403 are connected to each other by a bus 404. An input/output (I/O) interface 405 is also connected to the bus 404.

Generally, the following means may be connected to the I/O interface 405: an input means 406 including, for example, a touch screen, touch pad, keyboard, mouse, camera, microphone, accelerometer, gyroscope, etc.; an output means 407 including, for example, a liquid crystal display (LCD), speaker, vibrator, etc.; the storage means 408 including, for example, a magnetic tape, hard disk, etc.; and a communication means 409. The communication means 409 may allow the electronic device 400 to communicate with other devices wirelessly or by wire to exchange data. While FIG. 4 illustrates the electronic device 400 having various means, it should be understood that there is no requirement that all the illustrated means are implemented or provided. More or fewer means may be alternatively implemented or provided.

In particular, according to embodiments of the present disclosure, the processes described above with reference to the flow diagrams may be implemented as a computer software program. For example, an embodiment of the present disclosure includes a computer program product including a computer program carried on a non-transient computer-readable medium, the computer program containing program code for performing the method illustrated by the flow diagrams. In such an embodiment, the computer program may be downloaded and installed from a network via the communication means 409, or installed from the storage means 408, or installed from the ROM 402. The computer program, when executed by the processing means 401, performs the above functions defined in the method of the embodiment of the present disclosure.

The electronic device provided in the embodiment of the present disclosure and the method provided in the above embodiment belong to the same invention concept, where for technical details that are not described in detail in this embodiment, reference can be made to the above embodiment, and this embodiment has the same beneficial effects as the above embodiment.

An embodiment of the present application further provides a computer-readable medium having therein stored instructions or a computer program which, when run on a device, causes the device to execute any implementation of the data processing method provided in the embodiment of the present application.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, portable computer diskette, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing. In the present disclosure, the computer-readable storage medium may be any tangible medium containing or storing a program, where the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, where the computer-readable signal medium can send, propagate, or transmit a program for use by or in conjunction with an instruction execution system, apparatus, or device. The program code contained on the computer-readable medium may be transmitted using any appropriate medium, including but not limited to: a wire, optical cable, RF (Radio Frequency), etc., or any suitable combination of the foregoing.

In some implementations, a client and a server may communicate using any currently known or future developed network protocol, such as HTTP (Hyper Text Transfer Protocol), and may be interconnected with any form or medium of digital data communication (e.g., a communication network). Examples of the communication network include a local area network (“LAN”), wide area network (“WAN”), internet (e.g., the Internet), and peer-to-peer network (e.g., ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to perform the above method.

Computer program code for performing the operation of the present disclosure may be written in one or more programming languages or a combination thereof, where the above programming language includes but is not limited to an object-oriented programming language such as Java, Smalltalk, and C++, and also includes a conventional procedural programming language, such as a “C” language or similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit/module does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), application specific integrated circuit (ASIC), application specific standard product (ASSP), system on chip (SOC), complex programmable logic device (CPLD), and the like.

In the context of this disclosure, a machine-readable medium may be a tangible medium that can contain or store a program for use by or in conjunction with an instruction execution system, apparatus, or device. The machine-readable medium may be a machine-readable signal medium or machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, portable computer diskette, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

It should be noted that, in this description, the embodiments are described in a progressive manner, and each embodiment focuses on differences from other embodiments, and for same and similar parts between the embodiments, reference can be made to each other. For the system or apparatus disclosed in the embodiments, since it corresponds to the method disclosed in the embodiments, the description is simple, and for the relevant points, reference can be made to the description of the method section.

It should be understood that, in the present application, “at least one” refers to one or more, “a plurality” refers to two or more. “And/or”, which is used for describing an association relationship between associated objects, indicates that there may be three relationships, for example, “A and/or B” may represent three cases: the presence of A alone, the presence of B alone, and the presence of A and B simultaneously, where A and B may be singular or plural. A character “/” generally indicates that preceding and succeeding objects in association are in an “or” relationship. “At least one of the following items” or its similar expression refers to any combination of these items, including any combination of the singular or plural items. For example, at least one of a, b, or c, may represent: a, b, c, “a and b”, “a and c”, “b and c”, or “a and b and c”, where a, b and c may be single or plural.

It is further noted that, relational terms such as “first” and “second”, herein, are only used for distinguishing one entity or operation from another entity or operation without necessarily requiring or implying any such actual relationship or order between these entities or operations. Moreover, the term “include”, “contain”, or any other variation thereof, is intended to encompass a non-exclusive inclusion, so that a process, method, article, or device including a list of elements not only includes those elements but also includes other elements not expressly listed, or also includes elements inherent to such a process, method, article, or device. Without more limitations, an element defined by a statement “including a” does not exclude the presence of another identical element in a process, method, article, or device that includes the element.

The steps of the method or algorithm described in conjunction with the embodiments disclosed herein may be directly implemented using hardware, a software module executed by a processor, or a combination of the two. The software module may be provided in a random access memory (RAM), memory, read-only memory (ROM), electrically programmable ROM, electrically erasable programmable ROM, register, hard disk, removable disk, CD-ROM, or any other form of storage medium known in the art.

The above description of the disclosed embodiments enables those skilled in the art to implement or use the present application. Various modifications to these embodiments will be readily apparent to those skilled in the art, and the general principles defined herein may be implemented in other embodiments without departing from the spirit or scope of the present application. Therefore, the present application will not be limited to these embodiments shown herein but will conform to the widest scope consistent with the principles and novel features disclosed herein.

What is claimed is:

1. A data processing method, comprising:
acquiring a target image, a semantic-level feature of the target image, a pixel-level feature of the target image, a semantic-level codebook, and a pixel-level codebook, wherein a plurality of indices are shared between the semantic-level codebook and the pixel-level codebook, and different indices indicate different entries in the same codebook;
summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index;
comparing the distance sums corresponding to the plurality of indices to obtain a minimum value; and
determining an indexed result of the target image according to an index corresponding to the minimum value.

2. The method according to claim 1, wherein the semantic-level feature and the pixel-level feature are both continuous features, and the entry is a discrete feature.

3. The method according to claim 1, wherein the target image comprises a plurality of image patches, and the indexed result of the target image comprises an indexed result of each of the image patches; and
determining, for any of the image patches, the indexed result of the image patch comprises:
summing, for any of the indices, a distance between the entry indicated by the index in the semantic-level codebook and a semantic-level feature of the image patch and a distance between the entry indicated by the index in the pixel-level codebook and a pixel-level feature of the image patch to obtain a distance sum corresponding to the index for the image patch;
comparing the distance sums corresponding to the plurality of indices for the image patch to obtain a minimum value for the image patch; and
determining the indexed result of the image patch according to an index corresponding to the minimum value for the image patch.

4. The method according to claim 1, wherein the method is implemented by using a target model, the target model comprises a semantic-level encoder, a pixel-level encoder, the semantic-level codebook, and the pixel-level codebook;
the semantic-level encoder is configured for acquiring the semantic-level feature; and
the pixel-level encoder is configured for acquiring the pixel-level feature.

5. The method according to claim 4, wherein the target model further comprises a semantic-level decoder and a pixel-level decoder,
the semantic-level decoder is configured for processing an entry indicated by the indexed result in the semantic-level codebook to obtain a semantic-level prediction result of the target image; and
the pixel-level decoder is configured for processing an entry indicated by the indexed result in the pixel-level codebook to obtain a pixel-level prediction result of the target image; and
the method further comprises:
determining a model loss according to the semantic-level prediction result, the pixel-level prediction result, the semantic-level feature, the pixel-level feature, the entry indicated by the indexed result in the semantic-level codebook, and the entry indicated by the indexed result in the pixel-level codebook; and
updating the target model according to the model loss.

6. The method according to claim 5, wherein the determining the model loss comprises:
determining a first loss according to a similarity between the semantic-level prediction result and a semantic feature extracted by a teacher model for the target image, wherein, the semantic-level encoder is initialized according to the teacher model;
summing a reconstruction loss determined based on the pixel-level prediction result and the target image, a perceptual loss determined based on the pixel-level prediction result and the target image, and an adversarial loss determined based on the pixel-level prediction result to obtain a second loss;
determining a third loss according to the semantic-level feature, the pixel-level feature, the entry indicated by the indexed result in the semantic-level codebook, and the entry indicated by the indexed result in the pixel-level codebook; and
determining the model loss according to the first loss, the second loss, and the third loss.

7. The method according to claim 1, further comprising:
acquiring question text; and
generating answer text according to the question text and the indexed result.

8. The method according to claim 1, further comprising:
obtaining an image reconstruction result corresponding to the target image according to the indexed result and the pixel-level codebook.

9. The method according to claim 1, wherein the target image comprises a plurality of image patches, and the indexed result of the target image comprises an indexed result of each of the image patches; and
the method further comprises:
acquiring a text corresponding to the target image;
generating an index prediction result of each of the image patches according to a generation model and the text; and
updating the generation model according to a difference between the index prediction result of each of the image patches and the indexed result of each of the image patches.

10. The method according to claim 9, wherein after the updating the generation model, the method further comprises:
acquiring target text;
predicting at least one index by using the generation model and the target text; and
obtaining a generated image corresponding to the target text according to the at least one index and the pixel-level codebook.

11. An electronic device, comprising: a processor and a memory,
wherein the memory is configured to store instructions or a computer program; and
the processor is configured to execute the instructions or computer program in the memory to cause the electronic device to perform a data processing method, comprising:
acquiring a target image, a semantic-level feature of the target image, a pixel-level feature of the target image, a semantic-level codebook, and a pixel-level codebook, wherein a plurality of indices are shared between the semantic-level codebook and the pixel-level codebook, and different indices indicate different entries in the same codebook;
summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index;
comparing the distance sums corresponding to the plurality of indices to obtain a minimum value; and
determining an indexed result of the target image according to an index corresponding to the minimum value.

12. The electronic device according to claim 11, wherein the semantic-level feature and the pixel-level feature are both continuous features, and the entry is a discrete feature.

13. The electronic device according to claim 11, wherein the target image comprises a plurality of image patches, and the indexed result of the target image comprises an indexed result of each of the image patches; and
determining, for any of the image patches, the indexed result of the image patch comprises:
summing, for any of the indices, a distance between the entry indicated by the index in the semantic-level codebook and a semantic-level feature of the image patch and a distance between the entry indicated by the index in the pixel-level codebook and a pixel-level feature of the image patch to obtain a distance sum corresponding to the index for the image patch;
comparing the distance sums corresponding to the plurality of indices for the image patch to obtain a minimum value for the image patch; and
determining the indexed result of the image patch according to an index corresponding to the minimum value for the image patch.

14. The electronic device according to claim 11, wherein the data processing method is implemented by using a target model, the target model comprises a semantic-level encoder, a pixel-level encoder, the semantic-level codebook, and the pixel-level codebook;
the semantic-level encoder is configured for acquiring the semantic-level feature; and
the pixel-level encoder is configured for acquiring the pixel-level feature.

15. The electronic device according to claim 14, wherein the target model further comprises a semantic-level decoder and a pixel-level decoder,
the semantic-level decoder is configured for processing an entry indicated by the indexed result in the semantic-level codebook to obtain a semantic-level prediction result of the target image; and
the pixel-level decoder is configured for processing an entry indicated by the indexed result in the pixel-level codebook to obtain a pixel-level prediction result of the target image; and
the data processing method further comprises:
determining a model loss according to the semantic-level prediction result, the pixel-level prediction result, the semantic-level feature, the pixel-level feature, the entry indicated by the indexed result in the semantic-level codebook, and the entry indicated by the indexed result in the pixel-level codebook; and
updating the target model according to the model loss.

16. The electronic device according to claim 15, wherein the determining the model loss comprises:
determining a first loss according to a similarity between the semantic-level prediction result and a semantic feature extracted by a teacher model for the target image, wherein, the semantic-level encoder is initialized according to the teacher model;
summing a reconstruction loss determined based on the pixel-level prediction result and the target image, a perceptual loss determined based on the pixel-level prediction result and the target image, and an adversarial loss determined based on the pixel-level prediction result to obtain a second loss;
determining a third loss according to the semantic-level feature, the pixel-level feature, the entry indicated by the indexed result in the semantic-level codebook, and the entry indicated by the indexed result in the pixel-level codebook; and
determining the model loss according to the first loss, the second loss, and the third loss.

17. The electronic device according to claim 11, wherein the data processing method further comprises:
acquiring question text; and
generating answer text according to the question text and the indexed result.

18. The electronic device according to claim 11, wherein the data processing method further comprises:
obtaining an image reconstruction result corresponding to the target image according to the indexed result and the pixel-level codebook.

19. The electronic device according to claim 11, wherein the target image comprises a plurality of image patches, and the indexed result of the target image comprises an indexed result of each of the image patches; and
the data processing method further comprises:
acquiring a text corresponding to the target image;
generating an index prediction result of each of the image patches according to a generation model and the text; and
updating the generation model according to a difference between the index prediction result of each of the image patches and the indexed result of each of the image patches.

20. A non-transitory computer-readable medium, wherein the computer-readable medium has therein stored instructions or a computer program which, when run on a device, cause the device to perform a data processing method, comprising:
acquiring a target image, a semantic-level feature of the target image, a pixel-level feature of the target image, a semantic-level codebook, and a pixel-level codebook, wherein a plurality of indices are shared between the semantic-level codebook and the pixel-level codebook, and different indices indicate different entries in the same codebook;
summing, for any of the indices, a distance between an entry indicated by the index in the semantic-level codebook and the semantic-level feature and a distance between an entry indicated by the index in the pixel-level codebook and the pixel-level feature to obtain a distance sum corresponding to the index;
comparing the distance sums corresponding to the plurality of indices to obtain a minimum value; and
determining an indexed result of the target image according to an index corresponding to the minimum value.
